(19) United States
(12) Patent Application Publication
(10) Pub. No.: US 2005/0193329 A1
(43) Pub. Date: Sep. 1, 2005

(54) Systems and methods for creating page based applications using database metadata

(75) Inventor: Craig S. Kickel, Boise, ID (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Micron Technology, Inc.

(21) Appl. No.: 10/789,924

(22) Filed: Feb. 27, 2004

(51) Int. Cl. G06F 17/30; G06F 17/00

(52) U.S. Cl. 715/513; 707/1

(57) ABSTRACT

Systems and methods create a page for a page based application such as a web page for a web application. The systems and methods include reading metadata for a database. The metadata is translated into a page description language. The page description language may be HTML. Alternatively, the page description language may be a programming language such as the ColdFusion scripting language. The page description language may then be incorporated with other page description language or used as is to generate an application that interfaces with the database to retrieve and/or store data.

### FIELD

The present invention relates generally to creating page based computer applications, and more particularly to using database metadata to aid in the creation of such applications.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2003, Micron Technology, Inc. All Rights Reserved.

### BACKGROUND

The number of applications provided on the world-wide-web continues to grow with each passing day. Many web applications today interface with a database, either to retrieve information or to store information obtained from a user. In creating these applications, web developers are faced with a familiar pattern of development: request the database's schema, study it to learn the data model, translate the findings into a web application.

A great deal of up-front development is spent on this type of drudgery. The developer must often deal with copies of the database schema obtained from a database administrator. There are no guarantees that the schema itself is current or correct with respect to the database management system. Furthermore, the developer is typically developing code related to the database from scratch in a manner that attempts to mimic the data typing validation rules of the database. As a result, errors are often introduced due to mistranslation of column names, column types and column nullability.

Furthermore, because the work is often tedious, there is a tendency to attempt to shortcut the development process by omitting validation rules and error checking. As a result, the application may not be stable. The developer may iteratively add required validation and error checking, but this increases the development and testing time to produce an application.

### SUMMARY

The above-mentioned shortcomings, disadvantages and problems are addressed by the present invention, which will be understood by reading and studying the following specification.

In one aspect of the present invention a computerized method for creating a page for an application includes reading metadata for a relational database. The metadata is automatically translated into a page description language. The page description language may be any programming language, examples of such languages include ASP, Cold Fusion, C and C++. Alternatively, the page description language may be HTML or a combination of HTML and client scripting elements such as JavaScript and VBScript. The page description language may then be incorporated with other page description language or used as is to generate an application that interfaces with the database to retrieve and/or store data.

In a further aspect of the present invention, a system for creating web pages includes a database management system having metadata that describes the database, tables and columns under management. A metadata reader reads the metadata from the database, and translates the metadata into a page description language. The page description language may be suitable for processing by a web page generator such as the ColdFusion web page generator. The page description language may take the form of a Computer Gateway Interface (CGI) program or “as-is” HTML page.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of a hardware and software operating environment in which different embodiments of the invention may be practiced.

FIG. 2 is a diagram providing exemplary database metadata comprising table definitions and a constraint.

FIG. 3 is a flowchart illustrating a method for building a page based application from database meta data.

FIG. 4 is a diagram illustrating a user interface of an exemplary embodiment of the invention.

FIG. 5 illustrates exemplary page definition code produced by an embodiment of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

### Operating Environment

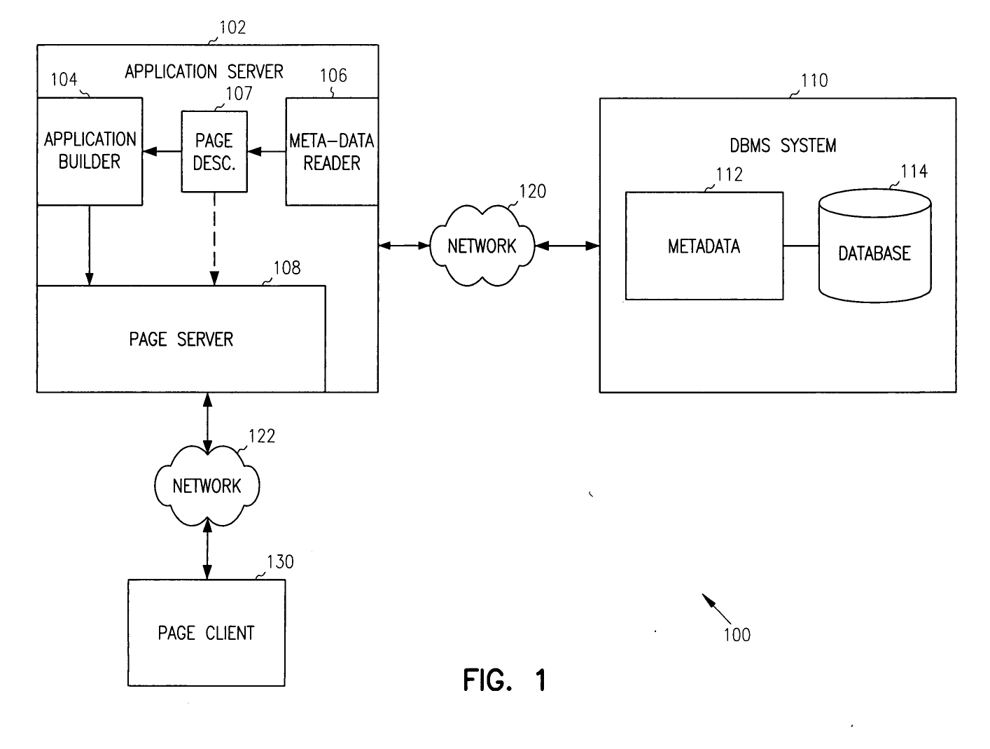

FIG. 1 is a block diagram of a hardware and software operating environment 100 in which different embodiments of the invention may be practiced. In some embodiments of the invention environment 100 includes a database management system (DBMS) 110 and application server 102 communicably coupled through network 120, and page client 130 communicably coupled to application server 102 through network 122. Network 120 and 122 may be the same network or different networks.

In some embodiments of the invention, DBMS 110 is a relational database management system. In one embodiment of the invention, DBMS 110 is the Sybase database management system available from Sybase, Inc. of Dublin, Calif. However, the invention is not limited to any particular relational database management system, and in alternative embodiments, DBMS 110 may be an Oracle DBMS from Oracle, Corp of Redwood City, Cailf., or an Informix DBMS from IBM Corp. of White Plains, N.Y. In further alternative embodiments, DBMS 110 may be an Access DBMS or SQL Server DBMS, both available from Microsoft Corp. of Redmond, Wash.

DBMS 110 typically manages data for one or more databases 114 and metadata 112 corresponding to each database 114. Database 114 typically comprises one or more tables, with each table having one or more columns that define the individual data elements in the table.

Metadata 112 comprises information about the tables and columns of database 114. In other words, metadata 112 is data used to describe the data of database 114. For example, metadata 112 includes schema information describing the layout of database 114. Such schema information typically includes table names, column names, column data types, column sizes, and flags indicating whether or not a column may contain a null value among other things. Metadata may also include constraints placed on the data. Typically constraints provide validation rules for the data. In addition, metadata may include stored procedures for a database. A stored procedure comprises a set of database commands that operate on the tables and columns of a database. The definition and use of constraints and stored procedures is known in the art.

Various database management systems provide differing methods to obtain metadata 112. For example, in some embodiments, APIs (Application Program Interfaces) may be used to obtain the metadata 112 from DBMS 110. In alternative embodiments, metadata 112 may be defined in files that are read from file system. The files defining metadata 112 may be text files or object files.

In some embodiments of the invention, application build system server 102 includes an application builder component 104, a metadata reader component 106, and a pager server 108. Application server 102 is typically communicably coupled to DBMS 110 through a network 120. Network 120 may be a corporate intranet or local area network. Additionally, network 120 may be a wired or wireless network, the internet, wide area network, and may or may not be the same.

Application builder component 104 comprises a software system that aids in the development of page based applications. In some embodiments, application builder component 104 is the ColdFusion product available from Macromedia, Inc. ColdFusion is a server-side scripting language that is designed for database interaction. It also includes HTML tag extensions that may be used to specify data validation rules. Once processed, a page description presented to ColdFusion results in a standard HTML page. This HTML page may include client scripting elements, for example JavaScript or VBScript elements. It should be noted however, the invention is not limited to any particular page based application builder, and that alternatives to ColdFusion exist and are within the scope of the invention.

In some embodiments, metadata reader 106 reads metadata 112 from DBMS system 110 and translates the metadata to a page description 107. The page description language may be any programming language, examples of such languages include ASP, ColdFusion, C and C++. In some embodiments, the page description comprises one or more ColdFusion scripts that can be supplied to application builder component 104. In alternative embodiments, the page description 107 comprises Hypertext Markup Language (HTML). In these embodiments, the HTML may be supplied directly to a page server as a page of a page-based application. After metadata reader 106 has produced the page description language from the metadata 112, it may be used as is, or it may be integrated with other page description code in order to produce a page based application. Further details on the translation functions performed by metadata reader 106 are provided below in the methods section.

The page description 107 may then be made available via a page server 108 to page clients 130 communicably coupled by network 122. Network 122 may be any type of wired or wireless network. In some embodiments, network 122 is the Internet.

In some embodiments, page server 108 is a web server such as the IIS (Internet Information Services) web server from Microsoft Corp, or the Apache web server available from the Apache Software Foundation. Similarly, page client 130 may be a web browser such as the Internet Explorer browser available from Microsoft Corp., or the Netscape Navigator browser available from AOL Time Warner. The present invention is not limited to any particular web server or web browser.

The components in the exemplary embodiments described above have been shown in FIG. 1 to reside in multiple systems. However, it should be noted that in alternative embodiments, the components may be distributed differently than shown in FIG. 1. For example, DMBS 110 may reside on same hardware and software platform as application server 102 eliminating the need for network 120. Alternatively, page server 108 may reside on a separate hardware and software system from application build server 102.

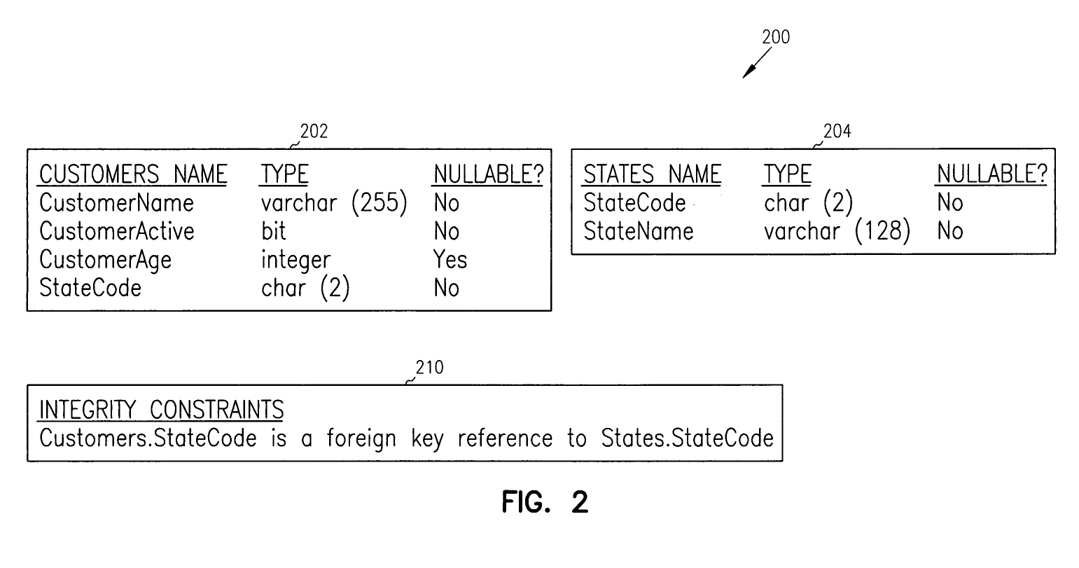

FIG. 2 is a diagram providing exemplary database metadata that will be used to illustrate the concepts of the present invention. The exemplary metadata includes table definitions for a customer table 202 and a state table 204, and an integrity constraint 210. Customer table 202 defines data for a customer, and includes a CustomerName column, a CustomerActive column, a CustomerAge column and a StateCode column. The CustomerName column is defined as a variable length character field having a maximum length of 255 characters. The CustomerActive column is defined as a bit value that may be either true or false. The CustomerAge column is defined as an integer value that may take on the range of integer values supported by a particular DBMS.

States table 204 in the example metadata 200 contains information about states, including a StateCode column and a StateName column. The StateCode column is a two character state code, i.e. the standard two-letter abbreviation for states. The StateName column is a variable length character field having a maximum size of 128 characters that contains the name of the state corresponding to the StateCode column.

As noted above, the tables and constraints described above are merely exemplary, the invention is not limited to any particular table definition, column type, column size, or constraint definition.

### Method for Creating a Page Description From Database Metadata

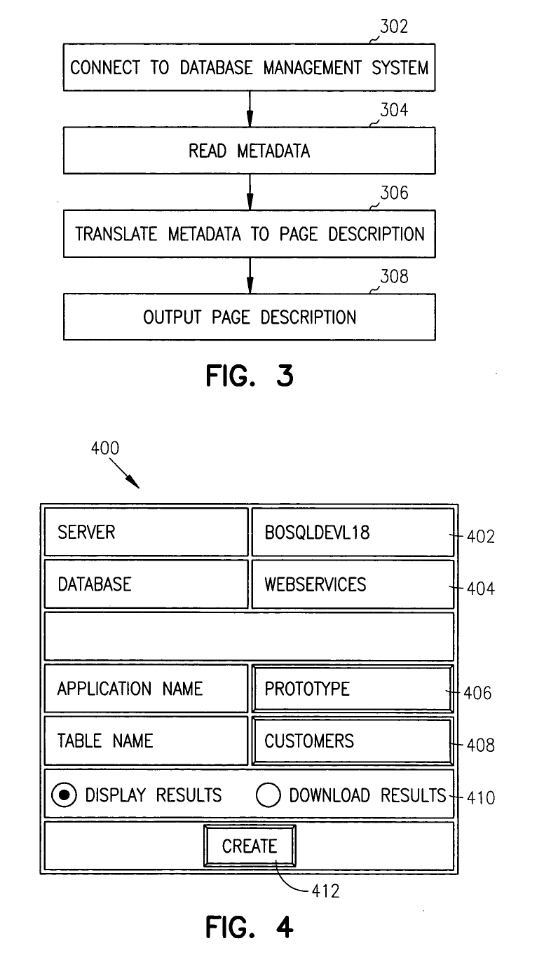

FIG. 3 is a flowchart illustrating a method for creating a page description using database metadata according to various embodiments of the invention. The method to be performed by the operating environment constitutes one or more computer programs made up of computer-executable instructions. Describing the method by reference to a flowchart enables one skilled in the art to develop such programs including such instructions to carry out the method on suitable computers and computer systems. The processor or processors of the computer typically executes the instructions from computer-readable media such as ROM, RAM, hard drives, CD-ROM, and/or DVD-ROM. The computer-readable media may also be a signal bearing media such as a wired or wireless network. The method illustrated in FIG. 3 is inclusive of acts that may be taken by an operating environment executing an exemplary embodiment of the invention.

In some embodiments of the invention, a component executing the method such as metadata reader 106 begins by connecting to a database management system (block 302). The connection process may vary depending on the database management system being used, but typically involves supplying authentication credentials, and also specifying a database server and database name to identify a particular database.

An exemplary user interface 400 used in some embodiments of the invention is illustrated in FIG. 4. User interface 400 may include server name 402, database name 404, application name 406, table name 408, results flag 410 and create button 412. Server name 402 identifies a particular database server with which the user desires to connect. Typically the server name will be a network name for a server hosting the desired DBMS. Database 404 identifies a particular database managed by the DBMS identified by server name 404. Application name 406 specifies a name for the application to be generated. The application name may be included in the page description generated according to the methods of the various embodiments of the invention.

In some embodiments, a table name 408 identifies a particular table for which metadata is desired. In alternative embodiments, all of the tables in the database may be used in the translation process. In further alternative embodiments, a list of tables may be supplied by the user.

Results flag 410 may be used to determine what to do with the results of the translation process. In some embodiments, the results may be displayed directly on the user's workstation. In alternative embodiments, the results may be downloaded to a page description file such as page description 107 described above.

Create button 412 may be used to indicate that the user has finished entering or setting the desired parameters and that the translation process may begin.

It should be noted that one or more of the above parameters may be “hard coded” into the process, in which case the user may not alter the hard coded value.

Returning to FIG. 3, a component executing the method then reads metadata from the database management system (block 304). In some embodiments, one or more calls to API functions provided by the DBMS may be used to read the desired metadata. In alternative embodiments, the metadata may be read from a file specified by a user. In these embodiments, it may not be necessary to connect to the DBMS, rather the file is located on the file system and opened.

After the desired metadata has been read, the metadata is then translated into a page description (block 306). The translation will vary depending on the data types and other metadata values read. In order to aid in understanding the present invention, the translation process will be described with reference to the exemplary metadata illustrated in FIG. 2 above. In addition, the discussion of the translation process that follows will assume that the page description is in the ColdFusion scripting language. Those of skill in the art will appreciate that other scripting language such as HTML or PDF could also be used.

Character Data

In some embodiments, columns defined to contain character may be rendered as a simple form input field. Typically the character data will have a defined length. For example, the CustomerName column has a defined length of at most 255 characters. Thus in some embodiments, the generated page description may specify a maxlength value of 255 characters. This allows the user to avoid the frustration of typing in extremely long names only to see them truncated by page server-side processing.

The available metadata for the CustomerName column also indicates that the column does not allow null values. From this the system determines that an entry for this element is required and generates the appropriate page description language. Thus in some embodiments, the ColdFusion script for the CustomerName column would be:

<cfinput type=“text” name=“CustomerName” maxlength=“255”
required=“yes”>

Bit Data

Columns defined to contain bit data typically can only accept values of 0 or 1 (alternatively True or False, On or Off, Yes or No etc.). In some embodiments, metadata indicating bit values are rendered within HTML as a form checkbox element. In alternative embodiments, a radio button may be rendered. Because of the checkbox's simple on/off structure, no further validation is typically required. The resulting ColdFusion translation for the CustomerActive bit value in some embodiments is thus:

<cfinput type=“checkbox” name=“CustomerActive”>

Numeric Data

In some embodiments, numeric data such as integer data may be rendered as a simple form input field. In alternative embodiments, validation rules may be added to insure that the supplied input is a valid numeric value (e.g. an integer). Enforcing this validation rule here provides the user with prompt feedback of data entry errors. Otherwise, a faulty, unchecked value might generate a database error along the lines of “Implicit conversion from datatype ‘VARCHAR’ to ‘INT’ is not allowed” in those embodiments where the DBMS is the Sybase DBMS.

In the exemplary metadata, the database schema for the CustomerAge column indicates that the column allows null values. In this case, the translation method determines that an entry for this element is not required. The resulting page description text for the CustomerAge column in some embodiments using ColdFusion is thus:

<cfinput type=“text” name=“CustomerAge” validate=“integer”
message=“The CustomerAge entry must be a valid integer.”
required=“no”>

Constraints

Constraints will be discussed using the StateCode column as an example. On the surface, this appears to be a two character text field similar to CustomerName example discussed above. However, by analyzing the metadata further, the system also determines that this column is a foreign key taken from the States table. This constraint implies that the only legal values are those that already exist within the States. StateCode column.

In some embodiments, a column such as the StateCode column of the Customers table may be translated as a simple form input field. In alternative embodiments, the constraint knowledge in the metadata is used and a column like the StateCode column is implemented as an HTML multi-selectable user interface element (e.g., a drop-down list box). The resulting drop-down list box may be populated with values drawn from the States.StateCode table. Thus in some embodiments, the ColdFusion page description for the StateCode column is:

<cfquery name=“StateCodeQuery”>
SELECT StateCode, StateName FROM States
</cfquery”>
<cfselect name=“StateCode” query=“StateCodeQuery”>

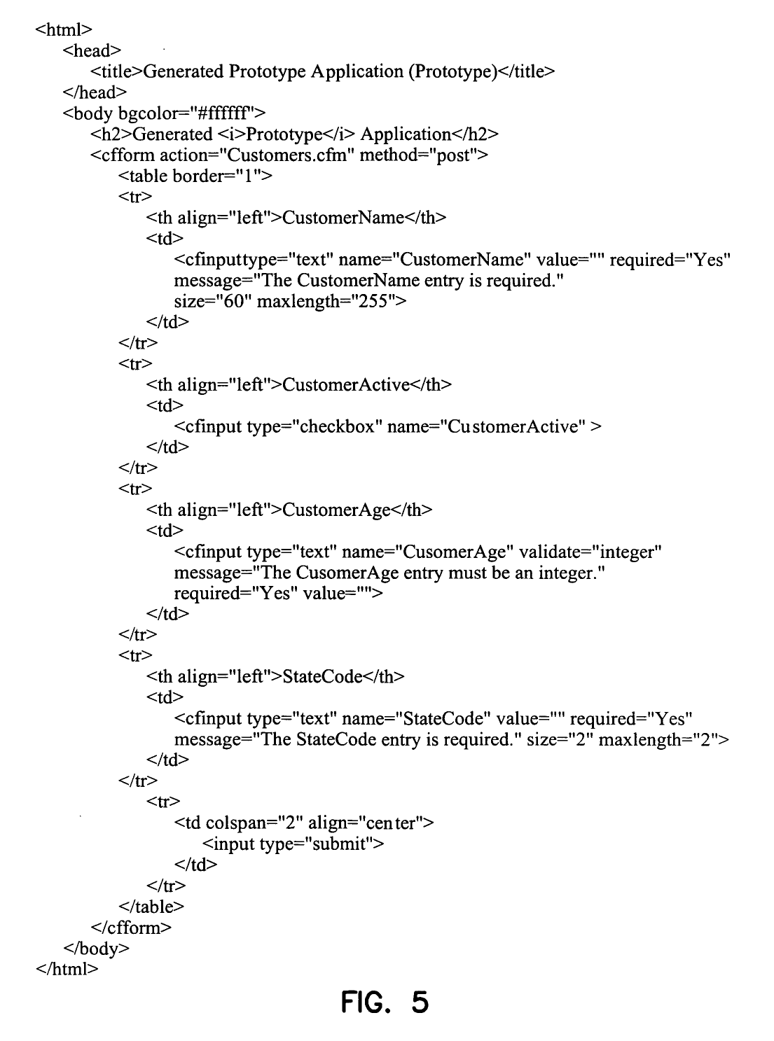

A component executing the method iterates through the metadata, translating the metadata elements into one or more page description elements as described above. As the metadata is translated, it is output to a page description file (block 308). As noted above, the page description file may comprise a ColdFusion script or HTML code. FIG. 5 illustrates a page description in the ColdFusion scripting language generated by an embodiment of the invention using the above-described method on the exemplary metadata of FIG. 2.

The method described above may be executed in a static fashion or a dynamic fashion. For example, in some embodiments, the method may be executed once to generate a page description, and then the page description used to define pages that are provided to page clients such as web browsers. Once defined, the system need not regenerate the page.

In alternative embodiments, the method may be executed dynamically. That is, the method may be executed each time a query for the page is received from a page client (e.g. a web browser) and the resulting generated page description sent back to the client in response to the request.

### Conclusion

Systems and methods for creating page descriptions from database metadata are disclosed. Although specific embodiments have been illustrated and described herein, it will be appreciated by those of ordinary skill in the art that any arrangement which is calculated to achieve the same purpose may be substituted for the specific embodiments shown. For example, while the description above has been provided in the context of creating a page description from metadata for a relational database management system, an object oriented database may also be used instead of, or in addition to, a relational database management system. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A computerized method for creating a page for an application, the method comprising:
reading metadata for a database;
translating the metadata into a page definition language; and
outputting the page definition language.

2. The computerized method of claim 1, wherein reading metadata includes reading column definitions for the database.

3. The computerized method of claim 2, wherein reading column definitions includes reading a column name and a column data type.

4. The computerized method of claim 2, wherein reading column definitions includes reading a null allowable indicator.

5. The computerized method of claim 1, wherein reading meta-data includes reading constraint definitions for at least one column.

6. The computerized method of claim 1, wherein reading metadata includes reading the metadata from a file.

7. The computerized method of claim 1, wherein reading the metadata includes invoking an API function to read the metadata.

8. The computerized method of claim 1, wherein translating the metadata includes translating a database column type to a page description element type.

9. The computerized method of claim 1, wherein translating the metadata includes translating a foreign key reference to a multi-selectable user interface element.

10. The computerized method of claim 1, wherein translating the metadata includes translating at least one constraint.

11. The computerized method of claim 10, wherein the at least one constraint comprises a validation rule.

12. The computerized method of claim 10, wherein the at least one constraint comprises an integrity rule.

13. The computerized method of claim 1, wherein the database comprises a relational database.

14. The computerized method of claim 1, wherein the database comprises an object-oriented database.

15. The computerized method of claim 1, wherein the page definition language comprises a ColdFusion scripting language.

16. The computerized method of claim 1, wherein the page definition language comprises Hypertext Markup Language (HTML).

17. The computerized method of claim 1, wherein the page definition language comprises a programming language.

18. The computerized method of claim 17, wherein the programming language comprises a ColdFusion scripting language.

19. A computerized method for creating a page for an application, the method comprising:
receiving a request for a web page;
reading metadata for a database;
translating the metadata into HTML defining the web page; and
sending the web page to the requestor.

20. A computerized method for creating a page for an application, the method comprising:
receiving a table identifier for a database;
reading metadata for the table from the database;
translating at least one column definition in the metadata into a ColdFusion scripting language;
translating at least one constraint in the metadata into the ColdFusion scripting language; and
outputting the ColdFusion scripting language to a page description file.

21. The computerized method of claim 20, wherein the database comprises a relational database.

22. A system for creating page descriptions, the system comprising:
a database management system (DBMS) operable to manage a database, the database having metadata; and
a metadata reader operable to read the metadata and translate the metadata into a page description language.

23. The system of claim 22, wherein the DBMS comprises a Sybase DBMS.

24. The system of claim 22, wherein the page description language comprises HTML.

25. The system of claim 22, wherein the page description language comprises a ColdFusion scripting language.

26. The system of claim 22, further comprising an application builder operable to read the page description language and generate a web page.

27. The system of claim 26, wherein the application builder comprises a ColdFusion system.

28. A computer system operable to generate a page based application, the computer system comprising:
at least one processor;
a memory coupled to the processor; and
an operating environment executed by the at least one processor from the memory, the operating environment comprising:
a database management system (DBMS) operable to manage a database, the database having metadata; and
a metadata reader operable to read the metadata and translate the metadata into a page description language.

29. The computer system of claim 28, wherein the DBMS comprises a Sybase DBMS.

30. The computer system of claim 28, wherein the page description language comprises HTML.

31. The computer system of claim 28, wherein the page description language comprises a ColdFusion scripting language

32. The computer system of claim 28, further comprising an application builder operable to read the page description language and generate a web page.

33. The computer system of claim 32, wherein the application builder comprises a ColdFusion system.

34. A computer-readable medium having computer executable instructions for performing a method for creating a page for an application, the method comprising:
reading metadata for a database;
translating the metadata into a page definition language; and
outputting the page definition language.

35. The computer-readable medium of claim 34, wherein reading metadata includes reading column definitions for the database.

36. The computer-readable medium of claim 35, wherein reading column definitions includes reading a column name and a column data type.

37. The computer-readable medium of claim 35, wherein reading column definitions includes reading a null allowable indicator.

38. The computer-readable medium of claim 34, wherein reading meta-data includes reading constraint definitions for at least one column.

39. The computer-readable medium of claim 34, wherein reading metadata includes reading the metadata from a file.

40. The computer-readable medium of claim 34, wherein reading the metadata includes invoking an API function to read the metadata.

41. The computer-readable medium of claim 34, wherein translating the metadata includes translating a database column type to a page description element type.

42. The computer-readable medium of claim 34, wherein translating the metadata includes translating a foreign key reference to a multi-selectable user interface element.

43. The computerized method of claim 34, wherein translating the metadata includes translating at least one constraint.

44. The computerized method of claim 43, wherein the at least one constraint comprises a validation rule.

45. The computerized method of claim 43, wherein the at least one constraint comprises an integrity rule.

46. The computer-readable medium of claim 34, wherein the database comprises a relational database.

47. The computer-readable medium of claim 34, wherein the database comprises an object-oriented database.

48. The computer-readable medium of claim 34, wherein the page definition language comprises a ColdFusion scripting language.

49. The computer-readable medium of claim 34, wherein the page definition language comprises Hypertext Markup Language (HTML).

50. A computer-readable medium having computer executable instructions for performing a method for creating a page for an application, the method comprising:
receiving a request for a web page;
reading metadata for a database;
translating the metadata into HTML defining the web page; and
sending the web page to the requestor.

51. A computer-readable medium having computer executable instructions for performing a method for creating a page for an application, the method comprising:
receiving a table identifier for a database;
reading metadata for the table from the database;
translating at least one column definition in the metadata into a ColdFusion scripting language;
translating at least one constraint in the metadata into the ColdFusion scripting language; and
outputting the ColdFusion scripting language to a page description file.

52. The method of claim 51, wherein the database comprises a relational database.

53. A method for receiving a web page, the method comprising:
issuing a request for a web page to a server, the request including a request for data from a database;
reading metadata for the database;
translating the metadata into a web page description language;
including the web page description language in the web page; and
sending the web page.

54. The method of claim 53, wherein the web page description language comprises HTML.

55. The method of claim 53, wherein the web page description language comprises a ColdFusion scripting language.

56. The method of claim 53, wherein the database comprises a relational database.
